(19) United States
(12) Patent Application Publication
(10) Pub. No.: US 2026/0208531 A1
(43) Pub. Date: Jul. 23, 2026

(54) TREAD PORTION OF A TIRE, AND METHOD AND ELASTOMERIC FORMULATION FOR PRODUCING A TREAD PORTION OF A TIRE

(71) Applicant: Mexichem Specialty Resins Inc., Avon Lake, OH (US)

(72) Inventors: Christopher Scilla, Broadview Heights, OH (US); Viswanathan Narayan, Strongsville, OH (US)

(21) Appl. No.: 19/448,893

(22) Filed: Jan. 14, 2026

Related U.S. Application Data
(60) Provisional application No. 63/746,693, filed on Jan. 17, 2025.

(51) Int. Cl. B60C 1/00; B29D 30/00; B29D 30/06; B29K 9/06; B29K 21/00; B29K 27/06; C08F 214/06; C08F 236/10; C08K 3/04; C08K 3/36; C08K 5/1535; C08L 9/06

(52) U.S. Cl. CPC B60C 1/0016; B29D 30/0005; B29D 30/0633; C08F 214/06; C08F 236/10; C08K 3/04; C08K 3/36; C08K 5/1535; C08L 9/06; B29K 2009/06; B29K 2021/003; B29K 2027/06

(57) ABSTRACT

An elastomeric formulation for producing a tread portion of a tire includes uncrosslinked rubber, reinforcing filler particles, polyvinyl chloride (PVC) particles, curative ingredients, and one or more additives. A tread portion of a tire includes (a) an elastomeric matrix comprising vulcanized rubber and polyvinyl chloride (PVC) and (b) reinforcing filler particles dispersed in the elastomeric matrix. A method of making a tread portion of a tire includes: forming a final batch mixture including uncrosslinked rubber, reinforcing filler particles, polyvinyl chloride (PVC) particles, one or more additives, and curative ingredients; rolling/milling the final batch mixture to form a precured rubber sheet; extruding the precured rubber sheet to form a green tread portion; assembling the green tread portion with other tire components; and exposing the green tread portion to heat and pressure to induce vulcanization, thereby forming a tread portion of a tire.

### RELATED APPLICATION

The present patent document claims the benefit of priority under 35 U.S.C. 119 (e) to U.S. Provisional Patent Application No. 63/746,693, which was filed on Jan. 17, 2025, and is hereby incorporated by reference in its entirety.

### TECHNICAL FIELD

The present disclosure relates generally to compositions for tire manufacture and more particularly to an elastomeric formulation for producing a tread portion of a tire.

### BACKGROUND

The tread portion of a tire comes into direct contact with the road and requires high wear-resistance, good traction characteristics on wet and dry surfaces, and low rolling resistance, among other properties. The tread portion is typically formed from a natural and/or synthetic rubber reinforced with particulate fillers such as carbon black and silica, as well as other additives, to provide the needed properties. It would be advantageous to develop a tire tread formulation that allows for a reduction in process costs and improvements in processing without sacrificing tire performance.

### SUMMARY

An elastomeric formulation for producing a tread portion of a tire comprises: uncrosslinked rubber; reinforcing filler particles; polyvinyl chloride (PVC) particles; curative ingredients; and one or more additives.

A tread portion of a tire comprises (a) an elastomeric matrix comprising vulcanized rubber and polyvinyl chloride (PVC) and (b) reinforcing filler particles dispersed in the elastomeric matrix.

A method of making a tread portion comprises: forming a final batch mixture including uncrosslinked rubber, reinforcing filler particles, polyvinyl chloride (PVC) particles, one or more additives, and curative ingredients; rolling/milling the final batch mixture to form a precured rubber sheet; extruding the precured rubber sheet to form a green tread portion; assembling the green tread portion with other tire components; and exposing the green tread portion to heat and pressure to induce vulcanization, thereby forming a tread portion of a tire.

### BRIEF DESCRIPTION OF THE DRAWINGS

The embodiments may be better understood with reference to the following drawing(s) and description. The components in the figures are not necessarily to scale. Moreover, in the figures, like-referenced numerals designate corresponding parts throughout the different views.

FIG. 1 is a schematic illustration of a tread portion of a tire that may be produced from the elastomeric formulation described in this disclosure.

FIG. 2 is a flow chart of a method to fabricate a tread portion of a tire.

FIG. 3 is a bar graph showing minimum torque results for exemplary elastomeric formulations in comparison with controls.

FIG. 4 is a bar graph showing maximum torque results for exemplary elastomeric formulations in comparison with controls.

FIG. 5 is a bar graph showing TS2 and T90 results for exemplary elastomeric formulations in comparison with controls.

FIG. 6 is a bar graph showing Mooney viscosity and hardness results for exemplary cured samples in comparison with controls.

FIG. 7 is a bar graph showing modulus and toughness results for exemplary cured samples in comparison with controls.

FIG. 8 plots ultimate elongation for exemplary cured samples in comparison with controls.

FIG. 9 plots tear strength for exemplary cured samples in comparison with controls.

FIG. 10 is a bar graph showing resistivity results for exemplary cured samples in comparison with controls.

FIG. 11 is a bar graph showing tan δ results for exemplary cured samples in comparison with controls.

FIG. 12 is a bar graph showing elastic modulus results for exemplary cured samples in comparison with controls.

### DETAILED DESCRIPTION

This disclosure describes the use of polyvinyl chloride (PVC) as a performance enhancing additive in rubber formulations for tire applications. The inclusion of PVC as a partial replacement for traditional fillers (e.g., silica particles) in rubber formulations for various parts of a tire has been investigated. Experiments described below on exemplary tire tread rubber formulations show that the partial replacement of silica particles with PVC leads to various benefits compared to formulations that do not include PVC. These benefits may include lower mixing energy requirements, higher scorch protection, reduced rolling resistance and/or improved snow traction. Notably, these benefits can be achieved with little to no loss in mechanical properties or other tire performance indicators.

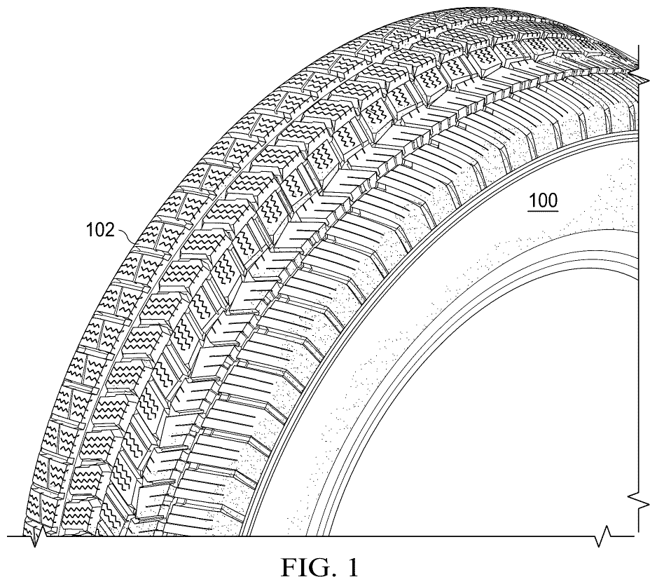

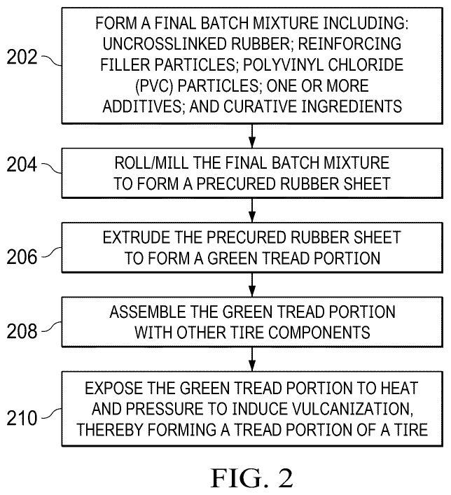

Thus, described in this disclosure is an elastomeric formulation for producing a tread portion of a tire, a tread portion of a tire as shown for example in FIG. 1, and a method of making a tread portion of tire, as shown by the flow chart of FIG. 2. First, the elastomeric formulation is described, and then the tread portion of the tire and the method of making the tread portion are discussed.

The elastomeric formulation includes uncrosslinked rubber, reinforcing filler particles, polyvinyl chloride (PVC) particles, curative ingredients and one or more additives. As mentioned above, the PVC particles are incorporated as partial replacements for traditional filler particles. The PVC particles may have a form of hollow particles or solid, non-hollow particles. The elastomeric formulation may include one or both forms of the PVC particles. In some examples, the PVC particles may be included in the formulation in an amount of at least 5 phr, at least 10 phr, or at least 20 phr. Also or alternatively, the PVC particles may be included in the formulation in an amount of 30 phr or less, 20 phr or less, or 10 phr or less. The one or more additives may include a compatibilizer for the PVC particles. For example, the compatibilizer may comprise one or more aliphatic resins, such as Struktol® RP 28. The compatibilizer for the PVC particles may be present in an amount of at least at least 1 phr, at least 3 phr, or at least 5 phr. Also or alternatively, the compatibilizer for the PVC particles may be present in an amount of 8 phr or less, or 6 phr or less, or 4 phr or less. The PVC particles may have any features or properties described in U.S. Patent Application Publication 2022/0081545 (“US 2022/0081545”), which is hereby incorporated by reference in its entirety. Also or alternatively, the PVC particles may be fabricated as described in US 2022/0081545 or may be obtained from commercial sources.

The reinforcing filler particles that are partially replaced by the PVC particles may include carbon black and/or silica particles. In some examples, the silica particles may be included in the formulation in an amount of 65 phr or less, 50 phr or less, 35 phr or less, or 20 phr or less. Also or alternatively, the silica particles may be included in the formulation in an amount of at least 10 phr, at least 25 phr, or at least 40 phr. The one or more additives may include an organosilane for reaction with silanol groups on surfaces of the silica particles during vulcanization. The organosilane may comprise a sulfur-containing organosilane, such as Evonik Si-69®.

The uncrosslinked rubber may comprise one or more synthetic and/or natural rubbers, such as a butadiene rubber. For example, the uncrosslinked rubber may comprise solution styrene butadiene (S-SBR) rubber (e.g., Sprintan® SLR-4601) and/or neodymium catalyzed butadiene rubber (BR) (e.g., Buna® CB-25).

The one or more additives may include a stabilizer comprising N-(1,3-dimethylbutyl)-N′-phenyl-p-phenylenediamine (6PPD) and/or wax to enhance ozone resistance. Also or alternatively, the one or more additives may include a naphthenic oil.

The curative ingredients may include a crosslinking agent comprising sulfur. It may also be beneficial for the curative ingredients to include an anti-oxidant and/or a vulcanization accelerator. The anti-oxidant may comprise 2,2,4-trimethyl-1,2-dihydroquinoline (TMQ), in one example. The vulcanization accelerator may comprise N-tert-butyl-2-benzothiazole sulfenamide (TBBS), zinc oxide (ZnO), and/or stearic acid.

The elastomeric formulation may exhibit a TS2 value of at least 6 min, wherein the TS2 value is obtained according to ASTM D5289, as described below. The TS2 value relates to the resistance of the elastomeric formulation to premature vulcanization. Also or alternatively, the elastomeric formulation may exhibit a T90 value of 19 min or less, 18 min or less, or 17 min or less, where the T90 value is also obtained according to ASTM D5289. The T90 value represents time to 90% cure, which is useful to establish cure times for the elastomeric formulation, making adjustments for thickness. It may be advantageous for the elastomeric formulation to exhibit a Mooney viscosity, which is a measure of resistance to flow, of 50 MU or less, 45 MU or less, 40 MU or less, or 35 MU or less.

Broadly speaking, the elastomeric formulation may exhibit any property or parameter value described in this disclosure. Additionally, the elastomeric formulation may have any composition described in this disclosure.

Referring now to FIG. 1, a tread portion 102 of a tire 100 may be fabricated from the elastomeric formulation described in this disclosure. The tread portion 102 includes an elastomeric matrix comprising vulcanized rubber and polyvinyl chloride (PVC) and reinforcing filler particles dispersed in the elastomeric matrix. The reinforcing filler particles may comprise carbon black and/or silica particles. The tread portion 102 may exhibit a tan δ at 60° C. of 0.14 or less, 0.13 or less, or 0.12 or less. Also or alternatively, the tread portion 102 may exhibit an elastic modulus at 12° C. of 12 MPa or less, 9 MPa or less, or 6 MPa or less. The tread portion may exhibit any property or parameter value described in this disclosure, such as the test values obtained for the cured samples described in the examples. A tire 100 including a tread portion 102 made from the elastomeric formulation is also envisioned.

Referring now to the flow chart of FIG. 2, a method of making a tread portion 102 of a tire 100 is also described. The method includes forming 202 a final batch mixture including uncrosslinked rubber, reinforcing filler particles, polyvinyl chloride (PVC) particles, one or more additives, and curative ingredients. The final batch mixture is rolled and/or milled 204 to form a precured rubber sheet, and the precured rubber sheet is extruded 206 to form a green tread portion. The green tread portion is assembled with 208 other tire components and is exposed 210 to heat and pressure to induce vulcanization. Accordingly, a tread portion 102 of a tire 100 is formed, as illustrated in FIG. 1.

Obtaining the final batch mixture may comprise multiple steps. In a first step, the noncrosslinked rubber, the reinforcing filler particles, the polyvinyl chloride (PVC) particles and the one or more other additives may be mixed together to form a master batch mixture, and then the master batch mixture may undergo rolling and/or milling. After the rolling/milling, the curing agents may be added to and mixed with the master batch mixture to form the final batch mixture. The mixing to form the master batch mixture may take place until a first drop temperature in a range from 300° C. to 340° C. is reached. The mixing to form the final batch mixture may take place until a second drop temperature in a range from 200° C. to 240° C. is reached.

The PVC particles may be included in the final batch mixture in an amount of at least 5 phr, at least 10 phr, or at least 20 phr. Also or alternatively, the PVC particles may be included in the final batch mixture in an amount of 30 phr or less, 20 phr or less, or 10 phr or less. The silica particles may be included in the final batch mixture in an amount of 65 phr or less, 50 phr or less, 35 phr or less, or 20 phr or less. Also or alternatively, the silica particles may be included in the final batch mixture in an amount of at least 10 phr, at least 25 phr, or at least 40 phr. The final batch mixture may have any composition, property or parameter as described in this disclosure for the elastomeric formulation.

### Examples

Three PVC resins were tested at two levels as a partial replacement for silica in a model tire tread formulation. The PVC resins tested were low-density PVC in the form of hollow particles (“E-66”) and solid (non-hollow) PVC (Vestolit G 121 (“VG-121”) and Vestolit G 215 (“VG-215”)) which were added to the elastomeric formulation at 10 and 20 phr. The two loadings of PVC were used to replace 30 and 45 phr of silica respectively. As indicated above, amounts of constituents of the elastomeric formulation are provided in phr, which means parts of the constituent per 100 parts rubber. Note that the reduction in silica loading is accompanied by a reduction in Si-69. This chemical is used to bond the silica to the rubber matrix and is normally added in ratio with the silica. The elastomeric formulations (HLSE1 through HLSE6) prepared in this investigation are provided in Table 1. Two control formulations (Control 1 and Control 2) that did not contain PVC were prepared and tested also for comparison.

TABLE 1
Constituents of elastomeric formulations that were mixed, molded and tested

| | Batch | | | | | | | | |
|---|---|---|---|---|---|---|---|---|---|
| | Ingredient Name | Control 1 | HLSE1 | HLSE2 | HLSE3 | HLSE4 | HLSE5 | HLSE6 | Control 2 |
| Uncrosslinked | SLR-4601 | 75 | 75 | 75 | 75 | 75 | 75 | 75 | 75 |
| rubber | | | | | | | | | |
| Uncrosslinked | CB-25 | 25 | 25 | 25 | 25 | 25 | 25 | 25 | 25 |
| rubber | | | | | | | | | |
| Curative | ZnO | 2.5 | 2.5 | 2.5 | 2.5 | 2.5 | 2.5 | 2.5 | 2.5 |
| ingredient | | | | | | | | | |
| (vulcanization | | | | | | | | | |
| accelerator) | | | | | | | | | |
| Additive | Wax | 1.5 | 1.5 | 1.5 | 1.5 | 1.5 | 1.5 | 1.5 | 1.5 |
| Additive | 6PPD | 3.0 | 3.0 | 3.0 | 3.0 | 3.0 | 3.0 | 3.0 | 3.0 |
| (stabilizer) | | | | | | | | | |
| Curative | Stearic Acid | 1.0 | 1.0 | 1.0 | 1.0 | 1.0 | 1.0 | 1.0 | 1.0 |
| ingredient | | | | | | | | | |
| (vulcanization | | | | | | | | | |
| accelerator) | | | | | | | | | |
| Silica particles | Silica Solvay | 80.0 | 50.0 | 50.0 | 50.0 | 35.0 | 35.0 | 35.0 | 80.0 |
| Additive | Evonik Si-69 | 8.0 | 5.0 | 5.0 | 5.0 | 3.5 | 3.5 | 3.5 | 8.0 |
| (organosilane) | | | | | | | | | |
| Additive | Struktol RP-28 | | 3 | 3 | 3 | 6 | 6 | 6 | |
| (compatibilizer) | | | | | | | | | |
| Curative | Sulfur | 1.4 | 1.4 | 1.4 | 1.4 | 1.4 | 1.4 | 1.4 | 1.4 |
| ingredient | | | | | | | | | |
| (crosslinking | | | | | | | | | |
| agent) | | | | | | | | | |
| Carbon black | N234/9H | 7.0 | 7.0 | 7.0 | 7.0 | 7.0 | 7.0 | 7.0 | 7.0 |
| | Carbon Black | | | | | | | | |
| Curative | TMQ | 1.0 | 1.0 | 1.0 | 1.0 | 1.0 | 1.0 | 1.0 | 1.0 |
| ingredient | | | | | | | | | |
| (antioxidant) | | | | | | | | | |
| Curative | TBBS | 1.7 | 1.7 | 1.7 | 1.7 | 1.7 | 1.7 | 1.7 | 1.7 |
| ingredient | | | | | | | | | |
| (vulcanization | | | | | | | | | |
| accelerator) | | | | | | | | | |
| Additive | Napthenic Oil | 25.0 | 25.0 | 25.0 | 25.0 | 25.0 | 25.0 | 25.0 | 25.0 |
| PVC particles | VG-121 | | | | 10 | | | 20 | |
| PVC particles | VG-215 | | | 10 | | | 20 | | |
| PVC particles | E-66 | | 10 | | | 20 | | | |
| | MB Drop Temp | 320 | 320 | 320 | 320 | 320 | 320 | 320 | 320 |
| | Final Pass | 220 | 220 | 220 | 220 | 220 | 220 | 220 | 220 |
| | DropTemp | | | | | | | | |

Properties of the elastomeric formulations and cured samples representative of a tread portion of a tire were evaluated with a variety of tests. The results are provided in tabular form and are discussed below.

Table 2 includes results from ASTM D5289 tests carried out using a moving die rheometer (MDR), including minimum and maximum torque, TS2 and T90. Table 3 includes results for Mooney viscosity.

### Minimum Torque (Min S′)

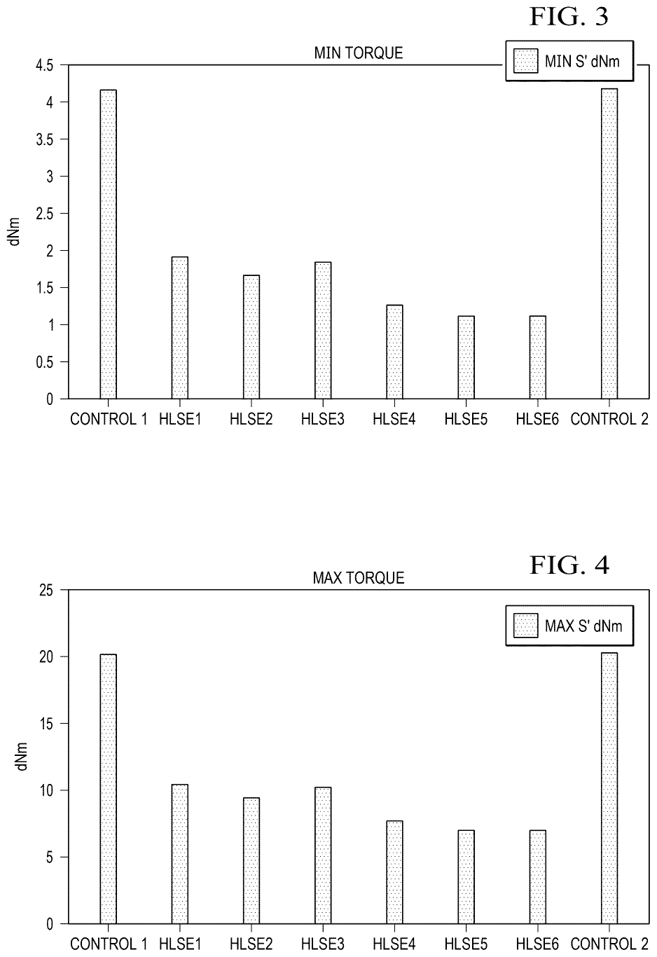

Tests to determine minimum torque were carried out according to ASTM D5289. Rheometer minimum torque tends to be indicative of viscosity, where lower is better. All elastomeric formulations including PVC exhibited significantly lower minimum torque values. Also, the data for the PVC-containing formulations all were within statistical range of each other. See FIG. 3.

### Maximum Torque (Max S′)

Tests to determine maximum torque were carried out according to ASTM D5289. Maximum torque levels are controlled by specification. No significant changes were noted among elastomeric formulations including PVC. The results for all of the PVC-containing formulations were lower than the controls. See FIG. 4.

### T90

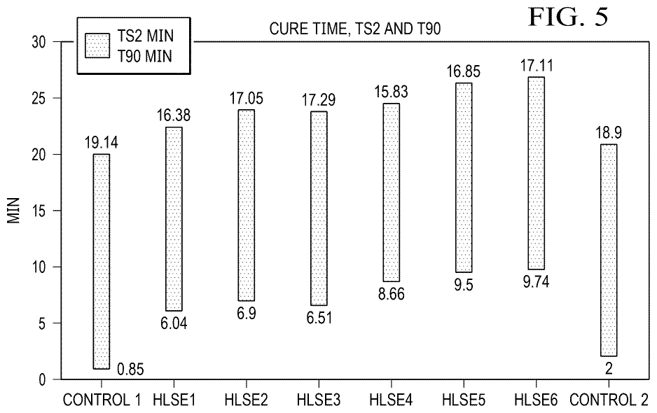

Tests to determine time to 90% cure or T90 were carried out according to ASTM D5289. Time to 90% cure is used to establish cure times (adjusted for thicknesses) during manufacturing. The elastomeric formulations containing PVC cured slightly faster than the controls, which is desirable as faster cure times can reduce overall processing time. Some dose dependence was observed. See FIG. 5.

### TS2

Tests to determine TS2 were carried out according to ASTM D5289. Time to 2 inch-lb rise is indicative of scorch resistance, that is, the time available before the elastomeric formulation begins to vulcanize or cure prematurely. Accordingly, longer TS2 times are better as they indicate a longer processing window. The elastomeric formulations including PVC were significantly less scorchy than the controls. See FIG. 5.

TABLE 2
ASTM D5289 results

| MDR | | | | | | | | | |
|---|---|---|---|---|---|---|---|---|---|
| (160C) | Units | Control 1 | HLSE1 | HLSE2 | HLSE3 | HLSE4 | HLSE5 | HLSE6 | Control 2 |
| Min S′ | dNm | 4.154 | 1.909 | 1.66 | 1.84 | 1.256 | 1.115 | 1.114 | 4.178 |
| Max S′ | dNm | 20.14 | 10.373 | 9.363 | 10.138 | 7.606 | 6.913 | 6.909 | 20.258 |
| TS1 | min | 0.73 | 4.18 | 4.97 | 4.48 | 6.76 | 7.51 | 7.68 | 0.73 |
| TS2 | min | 0.85 | 6.04 | 6.9 | 6.51 | 8.66 | 9.5 | 9.74 | 2 |
| T90 | min | 19.14 | 16.38 | 17.05 | 17.29 | 15.83 | 16.85 | 17.11 | 18.9 |

Of note in Table 2 is the TS2, which is the time it takes for the moving die rheometer (MDR) torque to rise 2 in-lbs. As indicated above, this measurement correlates to the resistance of the rubber formulation to premature vulcanization. The PVC-containing formulations (the HLSE # series) show much higher TS2 times than either of the controls.

### Mooney Viscosity

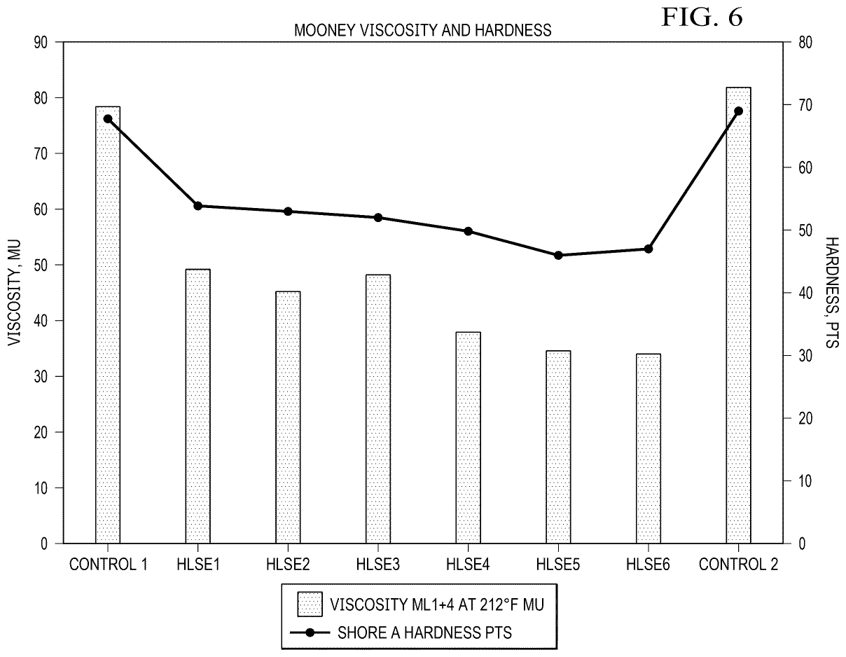

Mooney viscosity may be determined using a Mooney viscometer, where torque required to rotate a steel disc embedded in the elastomeric sample is measured over a specific time and converted into Mooney units (MU). Lower values of Mooney viscosity indicate better processability. Minor variability was noted for most formulations. The PVC-containing formulations were significantly lower in viscosity than the controls. Some dose dependence was observed. See Table 3 and FIG. 6.

TABLE 3
Mooney viscosity results

| Mooney | | | | | | | | | |
|---|---|---|---|---|---|---|---|---|---|
| Viscosity | Units | Control 1 | HLSE1 | HLSE2 | HLSE3 | HLSE4 | HLSE5 | HLSE6 | Control 2 |
| ML1 + 4 at | MU | 78.76 | 49.22 | 45.29 | 48.29 | 38 | 34.58 | 33.98 | 81.92 |
| 212° F. | | | | | | | | | |

Table 4 includes tensile results from ASTM D412 tests, including hardness, tensile strength, modulus and elongation.

### Shore A Hardness

Tests to determine Shore A hardness were carried out according to ASTM D412. Type A Hardness may be designed to an optimum level for overall product performance. A slight decrease in hardness was noted for all cured samples containing PVC. Some dose dependence was observed. See FIG. 6.

### Modulus M100

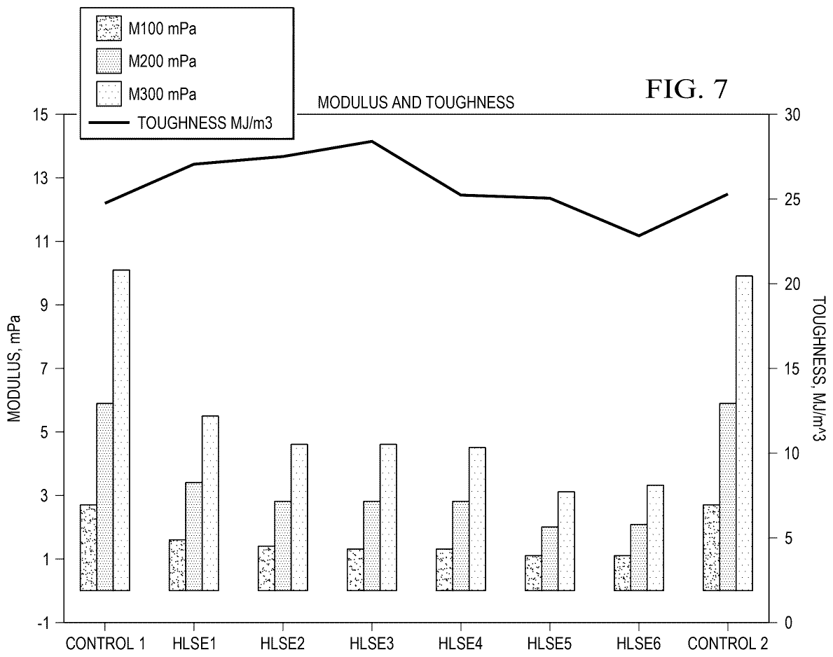

Tests to determine M100 were carried out according to ASTM D412. This parameter refers to axial stiffness in tension at 100% elongation. The PVC-containing cured samples exhibited a reduction in M100 compared to the controls. Some dose dependence was observed. See FIG. 7.

### Modulus M200

Tests to determine M200 were carried out according to ASTM D412. This parameter refers to axial stiffness in tension at 200% elongation. The PVC-containing cured samples exhibited a reduction in M200 compared to the controls. Some dose dependence was observed. See FIG. 7.

### Modulus M300

Tests to determine M300 were carried out according to ASTM D412. This parameter refers to axial stiffness in tension at 300% elongation. The PVC-containing cured samples exhibited a reduction in M300. Some dose dependence was observed. See FIG. 7.

### Toughness

Tests to determine toughness were carried out according to ASTM D412. Toughness is calculated from the area under the stress/strain curve, where higher values of toughness are preferred. The cured samples including 10 phr of PVC showed some improvement in toughness versus the 20 phr samples and the controls. See FIG. 7.

### Ultimate Elongation

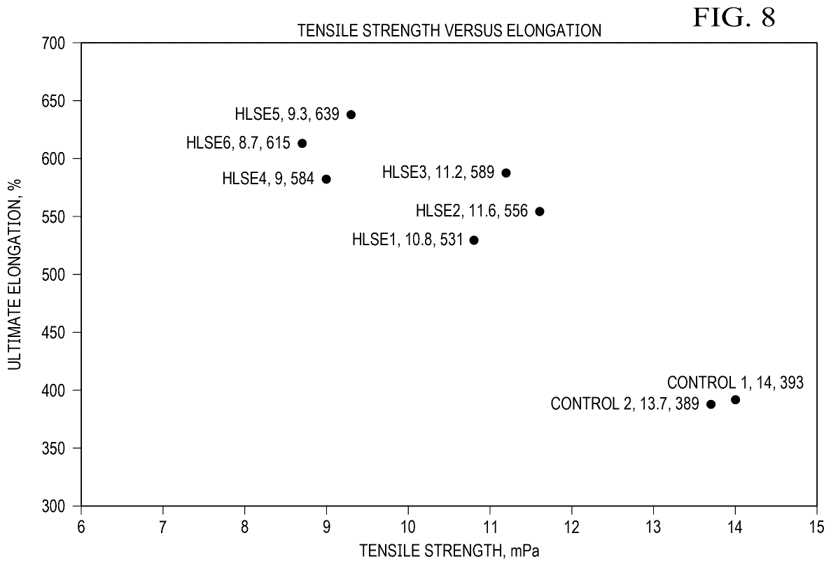

Tests to determine ultimate elongation were carried out according to ASTM D412. This parameter directly influences toughness (total area under the stress/strain curve), and higher values of ultimate elongation are preferred. The PVC-containing cured samples exhibited significantly longer elongation than the controls. Some dose dependence was observed. See FIG. 8.

TABLE 4
ASTM D412 tensile results

| Tensile | | Control | | | | | | | |
|---|---|---|---|---|---|---|---|---|---|
| Results | Units | 1 | HLSE1 | HLSE2 | HLSE3 | HLSE4 | HLSE5 | HLSE6 | Control 2 |
| Shore A | pts | 68 | 54 | 53 | 52 | 50 | 46 | 47 | 69 |
| Hardness | | | | | | | | | |
| Tensile | mPa | 14 | 10.8 | 11.6 | 11.2 | 9 | 9.3 | 8.7 | 13.7 |
| Strength | | | | | | | | | |
| M100 | mPa | 2.7 | 1.6 | 1.4 | 1.3 | 1.3 | 1.1 | 1.1 | 2.7 |
| M200 | mPa | 5.9 | 3.4 | 2.8 | 2.8 | 2.8 | 2 | 2.1 | 5.9 |
| M300 | mPa | 10.1 | 5.5 | 4.6 | 4.6 | 4.5 | 3.1 | 3.3 | 9.9 |
| Ultimate | % | 393 | 531 | 556 | 589 | 584 | 639 | 615 | 389 |
| Elongation | | | | | | | | | |
| Toughness | MJ/m³ | 24.7 | 27 | 27.5 | 28.4 | 25.2 | 25 | 22.8 | 25.3 |

### Tear Strength

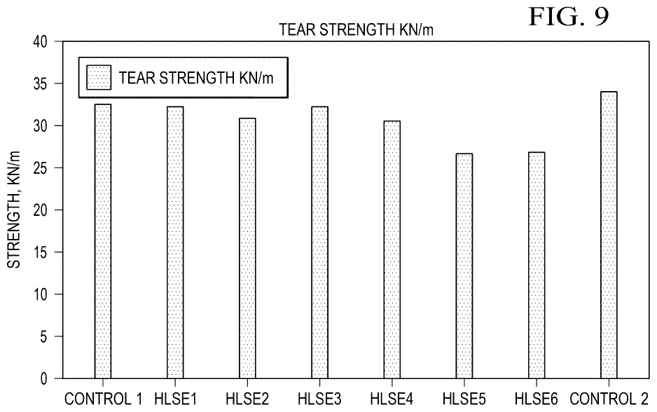

Tests to determine tear strength were carried out according to ASTM 624-00. Tear strength provides a measure of the force required to mechanically tear a material, where a higher tear strength is better. Some drop in tear strength was observed for the cured samples including 20 phr of PVC. See Table 5 and FIG. 9.

TABLE 5
ASTM 624-00 tear die C results

| | Units | Control 1 | HLSE1 | HLSE2 | HLSE3 | HLSE4 | HLSE5 | HLSE6 | Control 2 |
|---|---|---|---|---|---|---|---|---|---|
| Tear Strength | kN/m | 32.54 | 32.26 | 30.9 | 32.28 | 30.6 | 26.67 | 26.85 | 34.04 |

### Mixing

All formulations were mixed similarly to the controls. The PVC-containing formulations exhibited a lower power consumption than the controls and easier processibility.

### Specific Gravity

A ten percent reduction in specific gravity was observed for the samples containing 20 phr of PVC. See Table 6.

TABLE 6
Specific gravity results

| | Control 1 | HLSE1 | HLSE2 | HLSE3 | HLSE4 | HLSE5 | HLSE6 | Control 2 |
|---|---|---|---|---|---|---|---|---|
| Specific | 1.1965 | 1.1354 | 1.1308 | 1.1317 | 1.1049 | 1.103 | 1.1047 | 1.1973 |
| Gravity | | | | | | | | |

### Resistivity

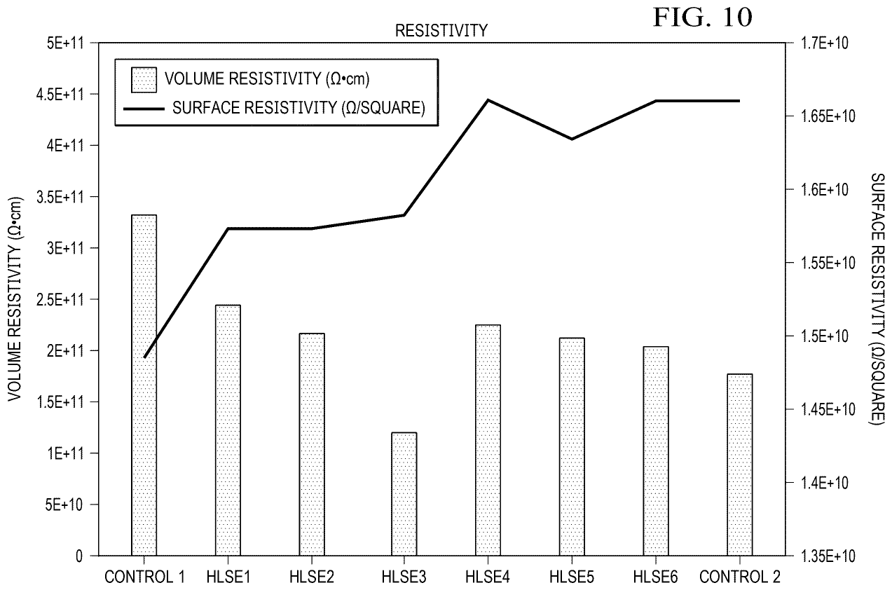

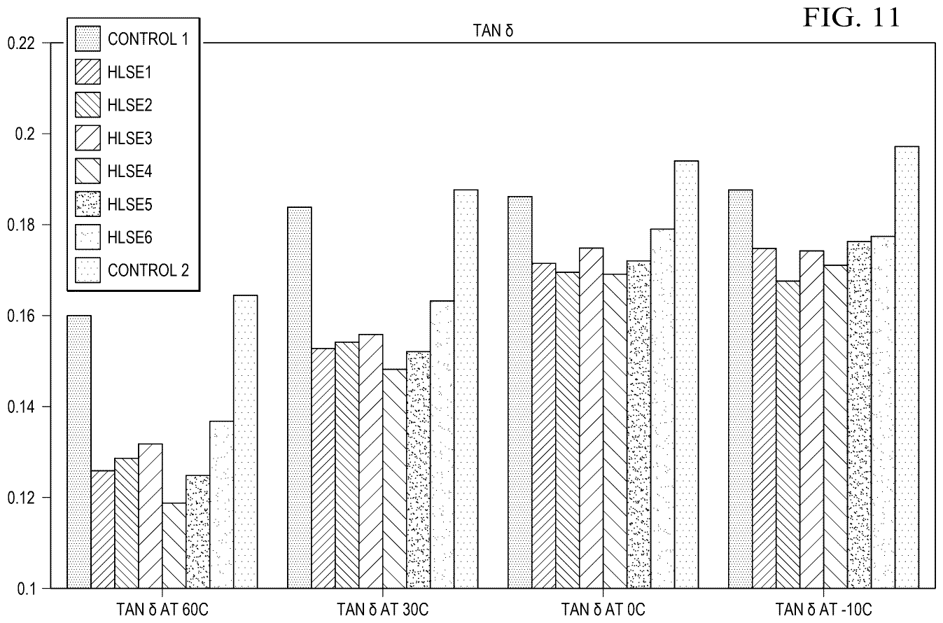

Volume resistivity and surface resistivity were measured. No significant changes were observed in the PVC-containing samples compared to the controls. See Table 7 and FIG. 10.

TABLE 7
Resistivity data

| | | Control | | | | | | | Control |
|---|---|---|---|---|---|---|---|---|---|
| | Units | 1 | HLSE1 | HLSE2 | HLSE3 | HLSE4 | HLSE5 | HLSE6 | 2 |
| Volume | (Ω · cm) × | 3.3191 | 2.4425 | 2.168 | 1.1965 | 2.255 | 2.1219 | 2.0453 | 1.7738 |
| Resistivity | 10¹¹ | | | | | | | | |
| Surface | (Ω/square) × | 1.4859 | 1.5733 | 1.573 | 1.5821 | 1.6607 | 1.6345 | 1.6607 | 1.6607 |
| Resistivity | 10¹⁰ | | | | | | | | |

### Tan δ at 60° C.

This parameter is equivalent to loss modulus G″ divided by storage modulus G′ and may be understood to represent the ratio of energy lost as heat (viscous behavior) to the energy stored and recovered (elastic behavior) when the samples are deformed. Tan δ at 60° C. is indicative of hysteresis, where lower values are preferred for tire performance as they indicate more elasticity and energy recovery, and thus better fuel economy. Moderate differences were observed amongst the PVC-containing cured samples, and all of them performed significantly better than the controls. Samples HLSE1 and HLSE4, which were prepared from elastomeric formulations including the hollow PVC particles (E-66), outperformed other samples, and the results seem to be dose dependent. See Table 8 and FIG. 11.

### Tan δ at 30° C.

This parameter is indicative of rolling resistance, where lower values are preferred. No significant differences were observed amongst the PVC-containing cured samples, and all of them performed significantly better than the controls. As with the previous data set, the samples containing E-66 outperformed other PVC-containing samples and the results appear to be dose dependent. See Table 8 and FIG. 11.

### Tan δ at 0° C.

This parameter is indicative of wet traction, where higher values are preferred. No significant differences were observed amongst the PVC-containing cured samples, and all of them performed significantly better than the controls. See Table 8 and FIG. 11.

### Tan δ at −10° C.

This parameter is indicative of snow/ice performance, where higher values are preferred. All of the PVC-containing cured samples performed slightly worse (exhibited lower values) than the controls. See Table 8 and FIG. 11.

TABLE 8
Tan δ data

| Tan δ | Control 1 | HLSE1 | HLSE2 | HLSE3 | HLSE4 | HLSE5 | HLSE6 | Control 2 |
|---|---|---|---|---|---|---|---|---|
| Tan δ | 0.1596 | 0.1259 | 0.1286 | 0.1319 | 0.1189 | 0.1248 | 0.1367 | 0.1645 |
| at 60° C. | | | | | | | | |
| Tan δ8 | 0.1836 | 0.1527 | 0.1541 | 0.1558 | 0.1481 | 0.152 | 0.1631 | 0.1874 |
| at 30° C. | | | | | | | | |
| Tan δ | 0.1859 | 0.1713 | 0.1694 | 0.1747 | 0.169 | 0.1719 | 0.1788 | 0.1938 |
| at 0° C. | | | | | | | | |
| Tan δ | 0.1875 | 0.1745 | 0.1674 | 0.174 | 0.1709 | 0.1759 | 0.1772 | 0.197 |
| at −10° C. | | | | | | | | |

### Elastic Modulus at 30° C.

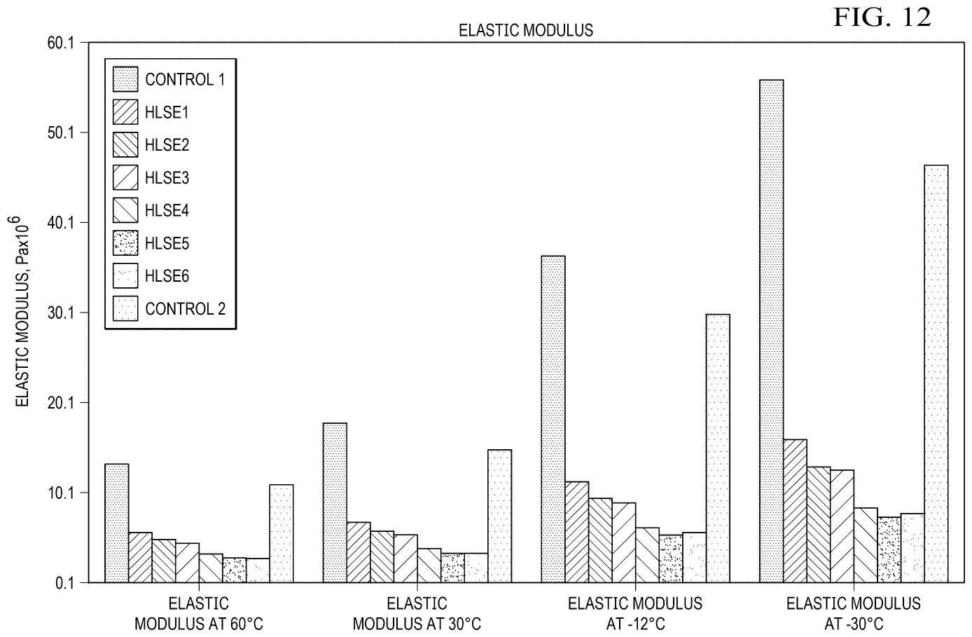

This parameter is indicative of dry cornering, where higher values are better. No significant differences were observed amongst the PVC-containing cured samples, and all samples performed slightly worse than the controls. The results appear to be dose dependent. See Table 9 and FIG. 12.

### Elastic Modulus at −12° C.

This parameter is indicative of snow traction, where lower values are better. All PVC-containing cured samples showed significant improvement compared to the controls. The results appear to be dose dependent. See Table 9 and FIG. 12.

TABLE 9
Elastic modulus data

| | Units | Control 1 | HLSE1 | HLSE2 | HLSE3 | HLSE4 | HLSE5 | HLSE6 | Control 2 |
|---|---|---|---|---|---|---|---|---|---|
| Elastic Modulus | Pa × 10⁶ | 13.31 | 5.78 | 4.94 | 4.58 | 3.36 | 2.94 | 2.91 | 11.08 |
| at 60° C. | | | | | | | | | |
| Elastic Modulus | Pa × 10⁶ | 17.88 | 6.93 | 5.88 | 5.5 | 3.98 | 3.46 | 3.46 | 14.9 |
| at 30° C. | | | | | | | | | |
| Elastic Modulus | Pa × 10⁶ | 36.4 | 11.36 | 9.51 | 9 | 6.26 | 5.52 | 5.75 | 29.93 |
| at −12° C. | | | | | | | | | |
| Elastic Modulus | Pa × 10⁶ | 55.92 | 16.09 | 13.08 | 12.75 | 8.49 | 7.47 | 7.83 | 46.51 |
| at −30° C. | | | | | | | | | |

On the tire performance side, two results from Tables 8 and 9 are highlighted. First is the 60° C. data set for tan δ. These measurements correlate to the rolling resistance of the tire. Lower tan δ corresponds to lower rolling resistance, which then translates to better fuel efficiency in the vehicle. The elastomeric formulations containing PVC show an approximately 20% reduction in the tan δ value. Further, the results of the elastic modulus of the material at −12° C., where lower results correlate to improved snow traction performance of the tire, indicate that the PVC-containing formulations show a PVC dose dependent 3-5 times reduction relative to the control.

Increases in processibility and reduction in specific gravity could indicate potential cost savings for compounds employing higher loadings of PVC additives tested. The samples prepared from the hollow PVC particles (E-66) did exhibit some difference versus the other PVC-containing samples, but in general the loading of PVC was a more significant factor than the grade of PVC for these experiments. Analysis of the DMA results indicate the E-66-containing samples (at higher loadings) may provide improvement with regard to hysteresis and rolling resistance, which is a key property for many new tire formulations. The results with respect to tan δ at −10° C. and elastic modulus at −12° C., being directionally different, may indicate some opportunity to optimize cure and formulation to improve snow tire and/or all-season tire performance. The effect of the PVC samples on TS2 is an unexpected result. The scorch protection offered by the PVC samples may be an attribute which could be beneficial to some compounds.

The results described in this disclosure may be important to the tire industry in several ways. Firstly, the lower mixing energy can translate into cost savings and higher productivity. Secondly, the improved scorch protection may give formulators more flexibility in designing the overall formulation, which may enable some cost savings as other scorch control additives may be able to be reduced. As indicated above, scorch refers to the premature vulcanization of the rubber formulation and defines the working time of the rubber mixture. Thirdly, better snow traction is desirable, especially in certain types of tire applications. Finally, and possibly most significantly, improved rolling resistance can translate into improved vehicle fuel efficiency. This is a significant benefit for the automotive industry which is facing increasing regulatory fuel efficiency requirements.

This disclosure also includes the following aspects:

A first aspect relates to an elastomeric formulation for producing a tread portion of a tire, the elastomeric formulation comprising: uncrosslinked rubber; reinforcing filler particles; polyvinyl chloride (PVC) particles; curative ingredients; and one or more additives.

A second aspect relates to the elastomeric formulation of the first aspect, wherein the PVC particles have a form of hollow particles.

A third aspect relates to the elastomeric formulation of the first or second aspect, wherein the PVC particles have a form of solid, non-hollow particles.

A fourth aspect relates to the elastomeric formulation of any preceding aspect, wherein the PVC particles are included in the formulation in an amount of at least 5 phr, at least 10 phr, or at least 20 phr.

A fifth aspect relates to the elastomeric formulation of any preceding aspect, wherein the PVC particles are included in the formulation in an amount of 30 phr or less, 20 phr or less, or 10 phr or less.

A sixth aspect relates to the elastomeric formulation of any preceding aspect, wherein the one or more additives include a compatibilizer for the PVC particles.

A seventh aspect relates to the elastomeric formulation of the preceding aspect, wherein the compatibilizer comprises one or more aliphatic resins, such as Struktol® RP 28.

An eighth aspect relates to the elastomeric formulation of the sixth or seventh aspect, wherein the compatibilizer for the PVC particles is present in an amount of at least at least 1 phr, at least 3 phr, or at least 5 phr.

A ninth aspect relates to the elastomeric formulation of any of the sixth through the eighth aspects, wherein the compatibilizer for the PVC particles is present in an amount of 8 phr or less, or 6 phr or less, or 4 phr or less.

A tenth aspect relates to the elastomeric formulation of any preceding aspect, wherein the PVC particles have any features described in US 2022/0081545, and/or wherein the PVC particles are fabricated as described in US 2022/0081545, which is hereby incorporated by reference in its entirety.

An eleventh aspect relates to the elastomeric formulation of any preceding aspect, wherein the reinforcing filler particles include carbon black and/or silica particles.

A twelfth aspect relates to the elastomeric formulation of any preceding aspect, wherein the silica particles are included in the formulation in an amount of 65 phr or less, 50 phr or less, 35 phr or less, or 20 phr or less.

A thirteenth aspect relates to the elastomeric formulation of the eleventh or twelfth aspect, wherein the silica particles are included in the formulation in an amount of at least 10 phr, at least 25 phr, or at least 40 phr.

A fourteenth aspect relates to the elastomeric formulation of any preceding aspect, wherein the one or more additives include an organosilane for reaction with silanol groups on surfaces of the silica particles during vulcanization.

A fifteenth aspect relates to the elastomeric formulation of any preceding aspect, wherein the organosilane comprises a sulfur-containing organosilane.

A sixteenth aspect relates to the elastomeric formulation of any preceding aspect, wherein the uncrosslinked rubber comprises one or more synthetic and/or natural rubbers.

A seventeenth aspect relates to the elastomeric formulation of any preceding aspect, wherein the uncrosslinked rubber comprises a butadiene rubber.

An eighteenth aspect relates to the elastomeric formulation of any preceding aspect, wherein the uncrosslinked rubber comprises solution styrene butadiene (S-SBR) rubber and/or neodymium catalyzed butadiene rubber (BR).

A nineteenth aspect relates to the elastomeric formulation of any preceding aspect, wherein the one or more additives include a stabilizer comprising N-(1,3-dimethylbutyl)-N′-phenyl-p-phenylenediamine (6PPD) and/or wax to enhance ozone resistance.

A twentieth aspect relates to the elastomeric formulation of any preceding aspect, wherein the curative ingredients include a crosslinking agent comprising sulfur.

A twenty-first aspect relates to the elastomeric formulation of any preceding aspect, wherein the curative ingredients include an anti-oxidant and/or a vulcanization accelerator.

A twenty-second aspect relates to the elastomeric formulation of the preceding aspect, wherein the anti-oxidant comprises 2,2,4-trimethyl-1,2-dihydroquinoline (TMQ).

A twenty-third aspect relates to the elastomeric formulation of the twenty-first or twenty-second aspect, wherein the vulcanization accelerator comprises N-tert-butyl-2-benzothiazole sulfenamide (TBBS), zinc oxide, and/or stearic acid.

A twenty-fourth aspect relates to the elastomeric formulation of any preceding aspect, wherein the one or more additives include a naphthenic oil.

A twenty-fifth aspect relates to the elastomeric formulation of any preceding aspect, wherein the elastomeric formulation exhibits a TS2 value of at least 6 min, where the TS2 value is obtained according to ASTM D5289.

A twenty-sixth aspect relates to the elastomeric formulation of any preceding aspect, wherein the elastomeric formulation exhibits a T90 value of 19 min or less, 18 min or less, or 17 min or less, and where the T90 value is obtained according to ASTM D5289.

A twenty-seventh aspect relates to the elastomeric formulation of any preceding aspect, wherein the elastomeric formulation exhibits a Mooney viscosity of 50 MU or less, 45 MU or less, 40 MU or less, or 35 MU or less.

A twenty-eighth aspect relates to the elastomeric formulation of any preceding aspect, wherein the elastic formulation exhibits any property value described in this disclosure.

A twenty-ninth aspect relates to the elastomeric formulation of any preceding aspect, wherein the elastomeric formulation has any composition described in this disclosure.

A thirtieth aspect relates to a tread portion of a tire made from the elastomeric formulation of any preceding aspect.

A thirty-first aspect relates to a tire including a tread portion made from the elastomeric formulation of any of the first through the twenty-ninth aspects.

A thirty-second aspect relates to a tread portion of a tire, the tread portion comprising: an elastomeric matrix comprising vulcanized rubber and polyvinyl chloride (PVC); and reinforcing filler particles dispersed in the elastomeric matrix.

A thirty-third aspect relates to the tread portion of the preceding aspect exhibiting a tan δ at 60° C. of 0.14 or less, 0.13 or less, or 0.12 or less.

A thirty-fourth aspect relates to the tread portion of the thirty-second or thirty-third aspect exhibiting an elastic modulus at 12° C. of 12 MPa or less, 9 MPa or less, or 6 MPa or less.

A thirty-fifth aspect relates to the tread portion of any of the thirty-second through thirty-fourth aspects exhibiting any property value described in this disclosure.

A thirty-sixth aspect relates to a method of making a tread portion of a tire, the method comprising: forming a final batch mixture including: uncrosslinked rubber; reinforcing filler particles; polyvinyl chloride (PVC) particles; one or more additives; and curative ingredients; rolling/milling the final batch mixture to form a precured rubber sheet; extruding the precured rubber sheet to form a green tread portion; assembling the green tread portion with other tire components; and exposing the green tread portion to heat and pressure to induce vulcanization, thereby forming a tread portion of a tire.

A thirty-seventh aspect relates to the method of the preceding aspect, wherein the forming of the final batch mixture comprises: mixing together the noncrosslinked rubber; the reinforcing filler particles; the polyvinyl chloride (PVC) particles; and the one or more other additives to form a master batch mixture; rolling/milling the master batch mixture; and adding the curing agents to the master batch mixture and mixing to form the final batch mixture.

A thirty-eighth aspect relates to the method of the thirty-second aspect, wherein the mixing to form the master batch mixture takes place until a first drop temperature in a range from 300° C. to 340° C. is reached.

A thirty-ninth aspect relates to the method of the thirty-seventh or thirty-eighth aspect, wherein the mixing to form the final batch mixture takes place until a second drop temperature in a range from 200° C. to 240° C. is reached.

A fortieth aspect relates to the method of any of the thirty-sixth through the thirty-ninth aspects, wherein the PVC particles are included in the final batch mixture in an amount of at least 5 phr, at least 10 phr, or at least 20 phr.

A forty-first aspect relates to the method of any of the thirty-sixth through the fortieth aspects, wherein the PVC particles are included in the final batch mixture in an amount of 30 phr or less, 20 phr or less, or 10 phr or less.

A forty-second aspect relates to the method of any of the thirty-sixth through the forty-first aspects, wherein the silica particles are included in the final batch mixture in an amount of 65 phr or less, 50 phr or less, 35 phr or less, or 20 phr or less.

A forty-third aspect relates to the method of any of the thirty-sixth through the forty-second aspects, wherein the silica particles are included in the final batch mixture in an amount of at least 10 phr, at least 25 phr, or at least 40 phr.

In addition to the features mentioned in each of the independent aspects enumerated above, some examples may show, alone or in combination, the optional features mentioned in the dependent aspects and/or as disclosed in the description above and shown in the figures.

What is claimed is:

1. An elastomeric formulation for producing a tread portion of a tire, the elastomeric formulation comprising:
uncrosslinked rubber;
reinforcing filler particles;
polyvinyl chloride (PVC) particles;
curative ingredients; and
one or more additives.

2. The elastomeric formulation of claim 1, wherein the PVC particles have a form of hollow particles.

3. The elastomeric formulation of claim 1, wherein the PVC particles have a form of solid, non-hollow particles.

4. The elastomeric formulation of claim 1, wherein the PVC particles are included in the formulation in an amount ranging from 5 phr to 30 phr.

5. The elastomeric formulation of claim 4, wherein the PVC particles are included in the formulation in an amount of at least 20 phr.

6. The elastomeric formulation of claim 1, wherein the one or more additives include a compatibilizer for the PVC particles, the compatibilizer comprising one or more aliphatic resins.

7. The elastomeric formulation of claim 6, wherein the compatibilizer for the PVC particles is present in an amount ranging from 1 phr to 8 phr.

8. The elastomeric formulation of claim 1, wherein the reinforcing filler particles include carbon black and/or silica particles.

9. The elastomeric formulation of claim 8, wherein the silica particles are included in the formulation in an amount from 10 phr to 65 phr.

10. The elastomeric formulation of claim 1 exhibiting a TS2 value of at least 6 min, wherein the TS2 value is obtained according to ASTM D5289.

11. The elastomeric formulation of claim 1 exhibiting a T90 value of 19 min or less, wherein the T90 value is obtained according to ASTM D5289.

12. The elastomeric formulation of claim 1 exhibiting a Mooney viscosity of 50 MU or less.

13. A tire including a tread portion made from the elastomeric formulation of claim 1.

14. A tread portion of a tire, the tread portion comprising:
an elastomeric matrix comprising vulcanized rubber and polyvinyl chloride (PVC); and
reinforcing filler particles dispersed in the elastomeric matrix.

15. The tread portion of claim 14 exhibiting a tan δ at 60° C. of 0.14 or less.

16. The tread portion of claim 14 exhibiting an elastic modulus at 12° C. of 12 MPa or less.

17. A method of making a tread portion of a tire, the method comprising:
forming a final batch mixture including:
uncrosslinked rubber;
reinforcing filler particles;
polyvinyl chloride (PVC) particles;
one or more additives; and
curative ingredients;
rolling/milling the final batch mixture to form a precured rubber sheet;
extruding the precured rubber sheet to form a green tread portion;
assembling the green tread portion with other tire components; and
exposing the green tread portion to heat and pressure to induce vulcanization, thereby forming a tread portion of a tire.

18. The method of claim 17, wherein the forming of the final batch mixture comprises:
mixing together the noncrosslinked rubber; the reinforcing filler particles; the polyvinyl chloride (PVC) particles; and the one or more other additives to form a master batch mixture;
rolling/milling the master batch mixture; and
adding the curing agents to the master batch mixture and mixing to form the final batch mixture.

19. The method of claim 17, wherein the PVC particles are included in the final batch mixture in an amount ranging from 5 phr to 30 phr.

20. The method of claim 17, wherein the silica particles are included in the final batch mixture in an amount ranging from 10 phr to 65 phr.
